(19) United States
(12) Patent Application Publication
(10) Pub. No.: US 2004/0041939 A1
(43) Pub. Date: Mar. 4, 2004

(54) Method of compensating for the integration of light by the vertical shift registers in an interline transfer charge coupled device

(76) Inventors: Gregory V. Hofer, Loveland, CO (US); Scott A. Woods, Bellvue, CO (US)

Correspondence Address: HEWLETT-PACKARD COMPANY, Intellectual Property Administration, P.O. Box 272400, Fort Collins, CO, 80527-2400, US

(21) Appl. No.: 10/231,799

(22) Filed: Aug. 28, 2002

(51) Int. Cl. H04N 5/235

(52) U.S. Cl. 348/362

(57) ABSTRACT

A digital camera calibrates its exposure metering to compensate for charge accumulated in the vertical shift registers of an interline transfer CCD due to light reaching the shielded shift registers. The camera performs a short exposure, optionally suppresses the usual shift of charge from sensor sites on the CCD into the vertical shift registers, and then reads the contents of the vertical shift registers. An average digital pixel brightness value is recorded for this trial photograph. The average digital pixel brightness value of the trial photograph is removed from the digital pixel brightness values in subsequent light metering photographs. Optionally, the average digital pixel brightness value of the trial photograph is removed from the digital pixel brightness values in a subsequent final photograph.

### FIELD OF THE INVENTION

The present invention relates generally to digital photography.

### BACKGROUND OF THE INVENTION

A typical digital camera uses a lens to project an image of a scene onto an electronic array light sensor. The electronic array light sensor often includes an array of charge coupled devices packaged in an integrated circuit. The integrated circuit is often called a CCD sensor, or simply a CCD.

FIG. 2 depicts a conceptual schematic diagram of a CCD 200. In particular, FIG. 2 depicts a type of CCD called an interline transfer CCD. Sensor sites 201 accumulate electrical charge at a rate in direct proportion to the intensity of light falling on them. Thus, assuming that no saturation has occurred, the charge accumulated in a sensor site is proportional to the integral of the intensity of the light that has fallen on the sensor site since integration began. This light integration property may be used to record a representation of a scene that is being imaged onto the surface of CCD 200 by the lens.

Typically, the sensor sites 201 are first emptied of charge by diverting their contents into the substrate of the CCD 200. This is sometimes called a “flush” operation. The sensor sites 201 are then allowed to accumulate charge for a measured exposure time. The charge in sensor sites 201 can then be transferred to adjacent vertical shift registers 202 by adjusting the electrical potential of the vertical shift registers 202 in relation to the electrical potential of the sensor sites 201 such that the charge migrates from the sensor sites 201 to the vertical shift registers 202. The vertical shift registers 202 are of a similar construction to the sensor sites 201, but are shielded from incident light by shielding material 206.

By a similar series of charge transfers, the charges can be moved row by row into horizontal shift register 203. Similarly, each row of charges may be transferred along horizontal shift register 203 to output stage 204. For each charge presented to it, output stage 204 momentarily presents a voltage on output pin 205, the voltage being in proportion to the amount of charge currently being presented to the output stage 204. The voltage at output pin 205 is thus proportional to the quantity of light that fell on a particular location on the CCD 200 just prior to the charge shift into the vertical shift registers 202.

The resulting sequence of voltages may be converted to a digital representation using an analog-to-digital (A/D) converter (not shown). The digital values represent the distribution of light on the CCD 200 during a period just prior to the charge shift into the vertical shift registers 202, and when properly interpreted, may be used to recreate the scene viewed by the digital camera. This collection of digital values may be referred to as an image file, a digital image, a digital photograph, or sometimes as simply a photograph or image. For the purposes of this disclosure, these digital values may also be called digital pixel brightness values.

Typically, a camera is configured so that brighter parts of a scene are represented by larger digital pixel brightness values. For example, a digital pixel brightness value of 500 usually represents a brighter pixel than does a digital pixel brightness value of 250. A camera could be constructed in which this relationship is reversed, and lower digital values represent brighter pixels. One of skill in the art will recognize that the invention may be embodied in cameras of either configuration.

In order to obtain a digital image of good quality, and especially to minimize various noise effects in the digital image, it is desirable to control the exposure level used for taking the photograph. The exposure level is typically controlled by varying the lens aperture or the exposure time, or both. A typical technique for achieving proper exposure is for the camera to take a trial photograph with a very short exposure time, and then take a final photograph using an exposure time determined by examining the characteristics of the trial photograph. In determining the proper exposure time for the final photograph, the camera will typically assume that the exposure level of each photograph is in direct proportion to the exposure time. That is, a doubling of exposure time will result in capturing twice the light, producing twice the charge in the sensor sites 201, resulting in twice the signal at the output 205.

When lighting of the scene is not changing rapidly, this assumption of proportionality is substantially accurate if a mechanical shutter is used to terminate the exposure or if the exposure time is sufficiently long in relation to the time required to shift the charges out of the CCD vertical shift registers 202. However, when no mechanical shutter is used and the exposure time is short, the relationship between exposure time (the time between the flush operation and the charge shift into the vertical shift registers 202) and the exposure level of the photograph may depart significantly from exact proportionality.

FIG. 3 depicts the result an actual measurement of the relation between exposure time and exposure level as measured by the average digital pixel brightness value in a digital image. On this log-log plot, a straight line would represent exact proportionality between exposure time and average digital pixel brightness value. Curve 301 shows the measurement of digital pixel brightness value for several exposure times. Line 302 shows the theoretical relationship that would occur if brightness value were exactly proportional to exposure time. Clearly, the relationship increasingly departs from exact proportionality as the exposure time gets very short.

It is desirable that a trial photograph used for exposure determination have a very short exposure time, both to maintain rapid operation of the camera and to ensure that saturation effects do not distort the exposure determination. However, a camera that relies on the exposure level read from a very short trial exposure may tend to overestimate the brightness of a scene, and thus underexpose the final photograph.

To ensure that photographs are properly exposed, a method is needed to compensate for the nonlinear relationship between exposure time and digital pixel brightness values when using an interline transfer CCD.

### SUMMARY OF THE INVENTION

A digital camera calibrates its exposure metering to compensate for charge accumulated in the vertical shift registers of an interline transfer CCD due to light reaching the shielded shift registers. The camera performs a short exposure, optionally suppresses the usual shift of charge from sensor sites on the CCD into the vertical shift registers, and then reads the contents of the vertical shift registers. An average digital pixel brightness value is recorded for this trial photograph. The average digital pixel brightness value of the trial photograph is removed from the digital pixel brightness values in subsequent light metering photographs. Optionally, the average digital pixel brightness value of the trial photograph is removed from the digital pixel brightness values in a subsequent final photograph.

### BRIEF DESCRIPTION OF THE DRAWINGS

FIG. 1 depicts a simplified block diagram of an example digital camera.

FIG. 2 depicts a conceptual schematic diagram of an interline transfer CCD sensor.

FIG. 3 depicts a measurement of the relation between exposure time and exposure level as measured by the average digital value in a digital image generated from an interline transfer CCD.

FIG. 4 shows the calibrated relationship between exposure time and average digital value, as compared with the ideal and uncorrected relationships.

FIG. 5 depicts a flowchart of an example embodiment of the invention.

### DETAILED DESCRIPTION OF THE PREFERRED EMBODIMENT

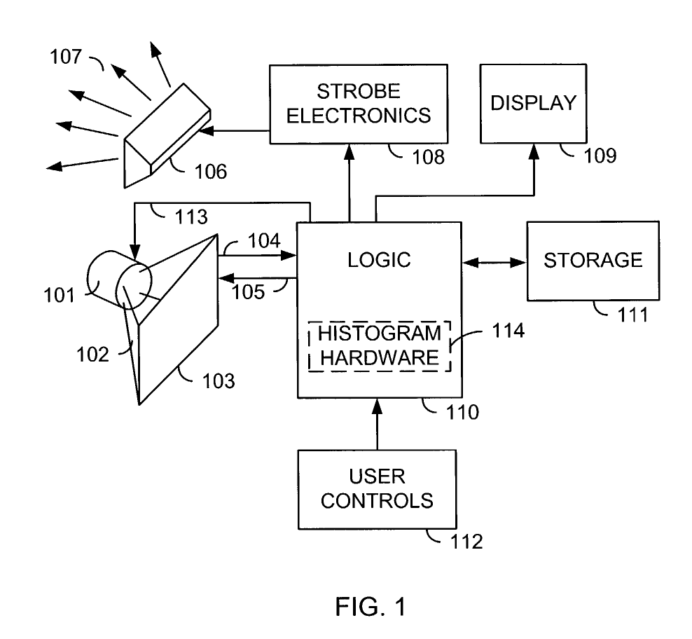

FIG. 1 depicts a simplified block diagram of an example digital camera. A lens 101 gathers light from a scene (not shown). The lens redirects the light so that the redirected light 102 forms an image of the scene on an electronic array light sensor 103. Electronic array light sensor 103 is a charge-coupled device (CCD) sensor of the interline transfer type. Image data 104 from electronic array light sensor 103 may be transmitted to a logic unit 110. The logic unit may comprise a microprocessor, a digital signal processor, memory, one or more application specific integrate circuits (ASICs), or some combination of these, and may control the operation of electronic array light sensor 103 using control signals 105. Logic unit 110 may also control the operation of lens 101 using control signals 113. Logic unit 110 may also process digital photographs in various ways, including applying image compression techniques to them. The camera may comprise a strobe 106 for supplying light 107 to the scene. Strobe 106 may be controlled by strobe electronics 108, which are in turn controlled by logic unit 110.

The camera may also comprise storage 111, which may be nonvolatile memory for relatively long term storage of digital photographs taken by the camera. Logic unit 110 may store digital image data in and retrieve digital image data from storage 111.

The camera may also comprise a display 109, which may be used for various purposes. Display 109 may provide a live viewfinder function, whereby the camera may repetitively display its rendition of the scene to aid the photographer in composing a photograph. Display 109 may also be used to review photographs for quality and composition. Display 109 may also be used in conjunction with user controls 112 to aid the photographer in controlling the function of the camera. User controls 112 may comprise buttons, dials, switches, touchpads, or other input devices.

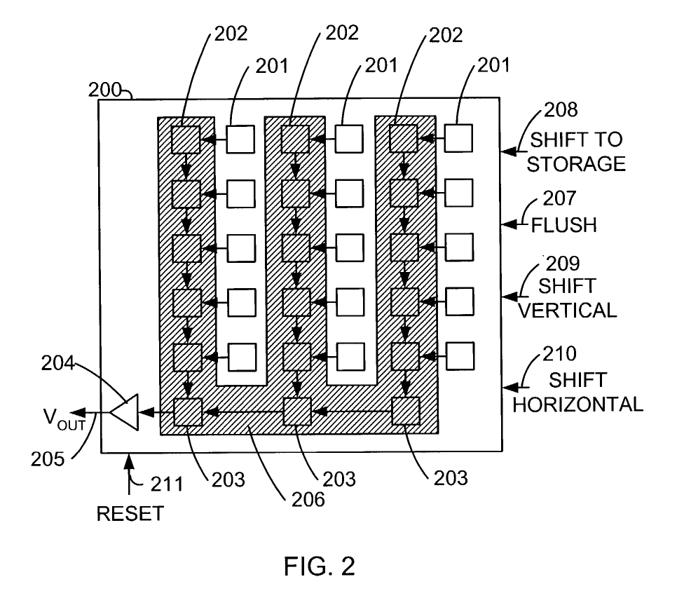

FIG. 2 depicts a conceptual schematic diagram of an interline transfer CCD sensor 200. Sensor sites 201 are arranged in a regular pattern so that each corresponds to and senses a particular location in an image projected onto the CCD 200 by the lens 101. The CCD 200 is controlled by a set of control signals 105, which may be operated by logic unit 110 of the digital camera. Only a limited number of sensor sites and other structures are depicted in FIG. 2 for clarity. Most CCDs have many more pixels than are depicted in FIG. 2, and the present invention may easily be embodied using a CCD with any number of pixels. CCD sensor 200 may be used in a camera to record a representation of a scene as follows.

A “flush” signal 207 may be asserted to the CCD 200, causing the CCD 200 to empty any charge from the sensor sites 201 by diverting their contents to the CCD substrate. A photographic exposure begins when the flush is complete and charge is again allowed to accumulate in the sensor sites 201 in response to light falling on them. The exposure may be terminated after a predetermined time by closing a mechanical shutter (not shown) or by shifting the accumulated charges from the sensor sited 201 into vertical shift registers 202 (sometimes called storage sites) in response to a “shift to storage” signal 208. The vertical shift registers 202 are similar in structure to the sensor sites 201 but are shielded from incident light by shielding material 206, which is placed onto the CCD during its manufacture. Charge shifts in a CCD are accomplished by manipulating the electrical potentials of the source site and the destination site so that the charges migrate to the destination site.

After the charges are placed in the vertical shift registers 202, they are shifted vertically row by row into horizontal shift register 203 in response to a “shift vertical” signal 209. With each vertical shift, each row of charges is shifted one row nearer to the horizontal shift register 203 through the vertical shift registers.

Once horizontal shift register 203 is loaded with a row of charges, the row of charges is shifted horizontally pixel by pixel to the CCD output stage 204. Each horizontal shift is in response to a “shift horizontal” signal 210. With each horizontal shift, each charge is shifted through the horizontal shift register one pixel closer to the output stage 204.

For each pixel of charge presented to the output stage 204, the output stage 204 momentarily places a voltage onto CCD output 205. This voltage may be read by an A/D converter, often part of the camera logic 110. A “reset” signal 211 may reset the output stage between pixels in preparation for the next horizontal shift.

After the charges have been read out of the CCD 200 and their corresponding voltages converted to digital values, the resulting array of values represents the distribution of light that fell onto the CCD 200 during the exposure time. This is a digital record of the image projected onto the CCD 200 by the camera lens 101. The process of shifting the charges out of the CCD 200 nominally empties the vertical and horizontal shift registers (202, 203) of charge, preparing them for the next charges available from the sensor sites 201.

One of skill in the art will recognize that this is a simplified conceptual model of a CCD, and that an actual CCD and its operation may involve other operating modes or other complexities. For example, the control signals for shifting charges may comprise several phases that must be sequenced properly to accomplish charge transfer. The sensor sites 201 may comprise overlaid color filters such that different sites respond to different sets of light wavelengths, enabling the reading of color images. The CCD may be of the interlaced type, having fewer vertical shift register storage sites than sensor sites, thus requiring the charges to be shifted out of the sensor sites in two or more fields. The CCD may have an operational mode that allows reading out only a subset of the pixels in order to permit fast, low-resolution operation. It will be apparent to one of skill in the art that the present invention may be embodied with equal facility in cameras with these CCD variations, as well as others.

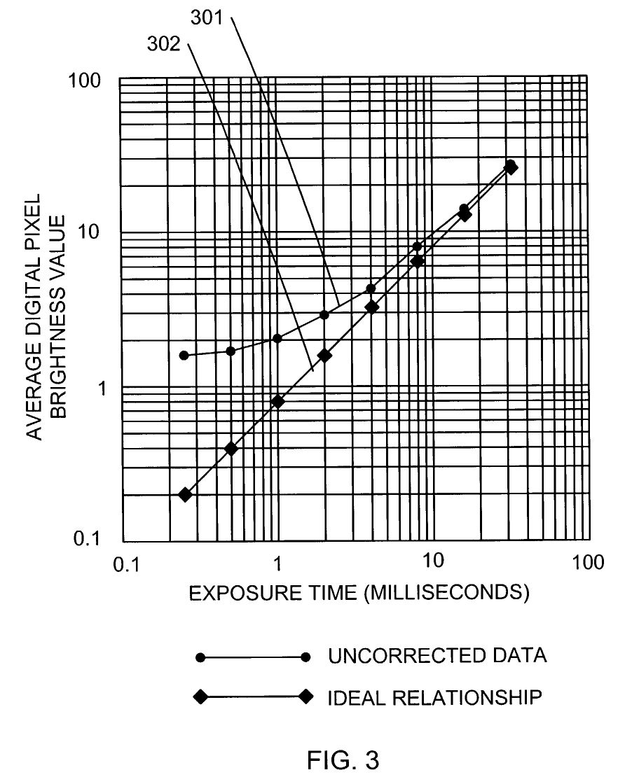

FIG. 3 depicts the result an actual measurement performed by the inventors of the relation between exposure time and exposure level as measured by the average digital pixel brightness value in a digital image. This experiment helps reveal a cause of some camera misexposure errors. As shown in FIG. 3, the relationship of digital pixel brightness values to exposure time may depart significantly from linearity when exposure times are short. A substantial cause of the departure is accumulation of charge in the vertical shift registers 202 due to integration of light in the vertical shift registers 202 during the time when the charges are being shifted out of the CCD 200. The vertical shift registers 202 are similar in structure to the sensor sites 201, and thus can accumulate charge when exposed to light.

While the vertical shift registers 202 and the horizontal shift register 203 are nominally shielded from incident light, the shielding may be imperfect. Some light may penetrate the shielding material 206, or propagate around the edges of the shielding material 206, reaching the vertical shift registers 202. The vertical shift registers 202 also accumulate charge in proportion to the light that reaches them, so light that reaches the vertical shift registers 202 causes the production of charge in excess of the charge that was produced in the sensor sites 201. If no mechanical shutter is used to block light from reaching the CCD 200 after the exposure time has passed, excess charge is accumulated in the vertical shift registers 202 after the exposure time has passed.

Under many photographic conditions, the excess charge is negligible. However, when the exposure time is very short due to bright ambient lighting conditions, more charge will be generated in the shielded vertical registers due to the higher level of light leaking past the register shields. The excess charge generated in the vertical shift registers 202 after the exposure time has passed may be significant in comparison with the charge generated in the sensor sites 201 during the exposure time.

This effect may cause the camera to have difficulty in metering the light levels in a scene to determine a proper exposure time. Typically, a digital camera uses its electronic array light sensor 103 both for measuring the brightness of a scene and for taking a final photograph. The camera may take one or more trial photographs of the scene for the purpose of measuring the light intensity. Based on the measured scene brightness, the camera computes parameters, including an exposure time, that will result in a properly exposed final photograph. For example, the camera may attempt to produce an image in which the average digital brightness value of the pixels in the image is about 18 percent of the highest available digital value. For example, a camera that can represent pixels with digital brightness values in the range of 0 to 1023 may try to set the average scene brightness at about 184 digital counts. Many other algorithms for setting photographic exposure are possible, and one of skill in the art will recognize that the present invention may be embodied in systems that use different exposure setting methods.

In computing an exposure time to be used for a final photograph, the camera may assume that the digital pixel brightness values registered by the camera will vary in exact proportion to the exposure time. For example, the camera may assume that a pixel that registered a brightness value of 50 with an exposure time of 2 milliseconds will register a brightness value of 750 with an exposure time of 30 milliseconds. When the scene lighting is not changing rapidly, this assumption of proportionality may be substantially accurate when the exposure time is relatively long or when a mechanical shutter is used to terminate the exposure time.

However, a trial photograph used to determine the proper exposure time may not meet these conditions. Exposure metering trial photographs are often taken with short exposure times and without the use of a mechanical shutter. These exposure times will become especially short in bright lighting conditions. For example, the exposure time for a trial photograph may be 2 milliseconds. In this example case, the CCD sensor sites 201 thus integrate light and generate charge for only that 2 millisecond exposure time, after which the charges from the sensor sites 201 are shifted into the vertical shift registers 202.

Depending on the number of pixels in the CCD 200 and the operating mode, the time required to shift the pixel charges off of the CCD 200 and through output stage 204 may be 30 milliseconds or more. During this shifting out time, light may leak into the vertical shift registers 202 and cause them to accumulate charge in excess of the charge that was collected during the exposure time. Because the time required to shift the charges out of the CCD 200 is large in comparison with the exposure time, the excess charge may be significant in relation to the charge accumulated during the exposure time even thought the light reaching the vertical shift registers 202 may be very weak in relation to the light falling on the sensor sites 201.

Because the amount of excess charge is substantially independent of the exposure time, its effect will be proportionately greater on photographs with very short exposures, such as trial photographs used for exposure setting. The excess charge may cause the camera to overestimate the scene brightness, and thus underexpose a final photograph. For example, a trial photograph of 2 milliseconds exposure may result in a quantity of charge in the sensor sites 201 producing an average digital pixel brightness value of 20. In addition, during the shifting out of the charges, excess charge may be accumulated in the vertical shift registers 202 producing an additional digital pixel brightness value of 2. Thus the camera records that a 2 millisecond exposure results in an average digital pixel brightness value of 22. If the camera is programmed to attempt to set the average digital pixel brightness value at 184 as described above, it may estimate the required exposure time Tr as Tr=184/22*2 milliseconds=16.72 milliseconds.

However, when the final photograph is taken, only the charge accumulated in the sensor sites 201 changes with the lengthening of the exposure time. The excess charge is substantially unaffected. Using units of digital pixel brightness value, the average brightness Ba of the final photograph is then

Ba=20*16.72/2+2=169 counts.

This value is lower than the desired 184 counts, meaning that the final photograph is underexposed.

In an example embodiment of the invention, the camera measures the excess charge accumulated in the vertical shift registers and accounts for it in the computation of the exposure time for a final photograph. In one example method for measuring the excess charge, the camera performs a trial photograph with an extremely short exposure time, and suppresses the shifting of charge from the sensor sites 201 to the vertical shift registers 202. The sequence for taking this trial photograph may be 1) perform a flush operation, 2) allow charge to start accumulating, 3) wait a very short exposure time, possibly only 1 microsecond, but do not assert the “shift to storage” signal 208, 4) shift the charges out of the CCD 200 row by row and pixel by pixel, reading a digital pixel brightness value for each pixel.

Alternatively, the “shift to storage” signal 208 could be asserted in step 3) above. As long as the exposure time is very short, the charge accumulated in the sensor sites 201 and shifted into the vertical shift registers 202 should be negligible. This mode of operation may be necessary when using CCD timing systems that do not provide for suppression of the “shift to storage” signal 208.

Once this trial photograph is digitized, the resulting digital pixel brightness values represent essentially only the excess charge accumulated in the vertical shift registers 202, both because the exposure time was extremely short and because the charges from the sensor sites 201 were not shifted into the vertical shift registers 202. In the example above, the average digital pixel brightness value for this trial photographs is 2 counts.

The camera can now use this information in its exposure setting computations. Using the example above, the camera may take a trial photograph with an exposure time of 2 milliseconds, and compute an average brightness value of 22 from it. Knowing that 2 of those brightness counts are due to the excess charge, the camera can subtract that amount, and compute that the actual average digital brightness value should be 20 counts.

Using this average value, the camera can then compute the exposure time needed to achieve proper exposure as

Tr=184/(22−2)*2 milliseconds=18.4 milliseconds.

In taking a final photograph with this exposure time, the sensor sites 201 will respond with proportionately more signal. The average digital pixel brightness value for the final photograph will then be

20*18.4/2+2=186 counts

which is much closer to the desired value of 184 counts. The camera may optionally subtract the 2 counts of average brightness value that resulted from the excess charge from the values recorded for the final photograph as well, making the average digital pixel brightness value for the final photograph the desired 184 counts.

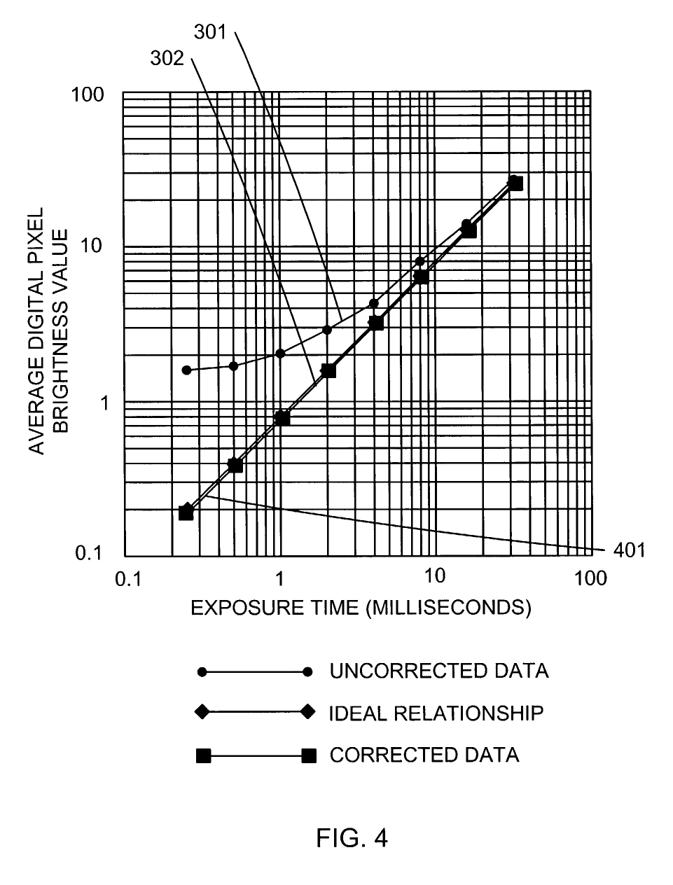

FIG. 4 shows the calibrated relationship between exposure time and average digital value, as compared with the ideal and uncorrected relationships. Line 302 shows the ideal relationship, in which average digital pixel brightness value is exactly proportional to exposure time. Curve 301 shows the uncorrected relationship, wherein light integration by the CCD vertical shift registers causes the relationship to depart from ideal linearity. Curve 401 shows the relationship after the application of an example embodiment of the invention. An average digital pixel brightness value for the excess vertical shift register charge was measured as described in the above example. This calibration average digital pixel brightness value was subtracted from each data point of curve 301. The resulting curve 401 lies much closer to the ideal line 302, indicating that the calibration method has substantially linearized the camera exposure relationship, making improved exposure determination possible.

One step in the calibration process involves computing an average digital pixel brightness value for a trial exposure. A camera may accomplish this computation in various ways. A microprocessor that is part of logic unit 110 may examine each pixel in an image and compute an average under control of a stored program. Alternatively, logic unit 110 may comprise dedicated circuitry 114 for constructing exposure histograms. An exposure histogram assigns each pixel brightness value to a “bin”, such that each bin contains the count of pixels with brightness values in a specified range. For example, the camera may be able to represent brightness values in a total range of 0 to 1023. This range may be divided into 64 bins, representing brightness value ranges of 0-15, 16-31, 32-47, and so forth. After construction of the histogram, the first histogram bin value will be the number of pixels in the image whose brightness values were between 0 and 15, inclusive. The second histogram bin value will be the number of pixels whose brightness values were between 16 and 31, inclusive. The rest of the 64 histogram bin values will be the number of pixels with brightness values in the respective ranges.

Because the histogram may be constructed by dedicated hardware 114, the computation of the average digital pixel brightness value may be facilitated. The microprocessor may need only to examine the histogram values, and compute a weighted average based on the number of pixels in each bin. The time required to compute the average digital pixel brightness value may be substantially reduced.

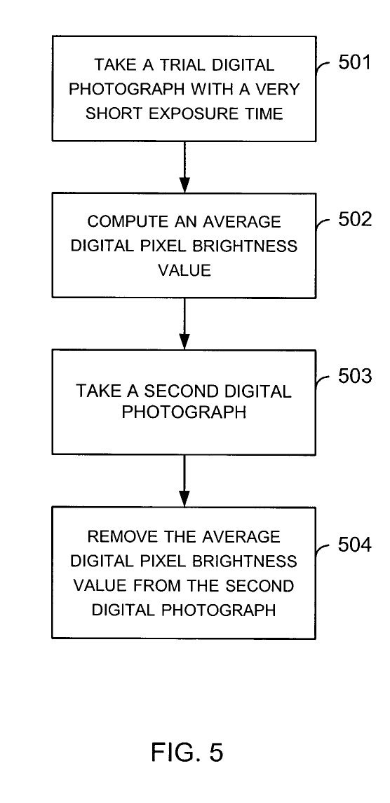

FIG. 5 depicts a flowchart of an example embodiment of the invention. In step 501, a trial photograph is taken with a very short exposure time. In step 502, an average digital pixel brightness value is computed for the trial photograph. In step 503, a second digital photograph is taken. In step 504, the average digital pixel brightness value is subtracted from the digital pixel brightness values in the second digital photograph.

In the above examples, it is assumed that the camera represents brighter pixels with higher digital pixel brightness values, and therefore the camera removes the effect of the charge accumulated in the vertical shift registers 202 by subtracting the average digital pixel brightness value from digital pixel brightness values in subsequent digital images. In a camera that represents brighter pixels with lower digital values, the camera may remove the effect of the excess charge by adding the average digital pixel brightness value from digital pixel brightness values in subsequent digital images.

The foregoing description of the present invention has been presented for purposes of illustration and description. It is not intended to be exhaustive or to limit the invention to the precise form disclosed, and other modifications and variations may be possible in light of the above teachings. For example, the computational complexity of computing an average digital pixel brightness value for the trial photograph may be reduced by controlling the CCD in such a way as to accumulate the charge from several rows of vertical shift registers into the horizontal shift register between instances of shifting the charges out of the horizontal shift register. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of compensating for the integration of light by shift registers in an interline transfer CCD, comprising the steps of:
a) taking a first digital photograph;
b) computing an average digital pixel brightness value in the first digital photograph due to the integration of light by the shift registers;
c) taking a second digital photograph; and
d) removing the average digital pixel brightness value of the first digital photograph from digital pixel brightness values in the second digital photograph.

2. The method of claim 1 wherein the second digital photograph is taken for the purpose of light metering.

3. The method of claim 1, further comprising the steps of:
a) taking a final digital photograph; and
b) removing the average digital pixel brightness value of the first digital photograph from digital pixel brightness values in the final digital photograph.

4. The method of claim 1, further comprising the step of suppressing a shift of charge from CCD sensor sites to CCD vertical shift registers.

5. The method of claim 1 wherein the step of computing the average digital pixel brightness value in the trial digital photograph is facilitated by dedicated hardware for constructing an exposure histogram.

6. A digital camera, comprising:
a) an interline transfer CCD electronic array light sensor having vertical shift registers; and
b) a logic unit that controls the interline transfer CCD electronic array light sensor and receives image data from the interline transfer CCD electronic array light sensor; the logic unit configured to compensate for light integration in the vertical shift registers by taking a trial digital photograph, computing an average digital pixel brightness value of the trial digital photograph, and removing the average digital pixel brightness value of the trial digital photograph from pixel brightness values in a second digital photograph.

7. The digital camera of claim 6 wherein the interline transfer CCD electronic array light sensor further comprises sensor sites, and wherein electrical charge accumulated in the sensor sites is not shifted into the vertical shift registers during the taking of the trial photograph.

8. The digital camera of claim 6 wherein the second digital photograph is used in determining a proper exposure time for a final digital photograph, and wherein the logic unit is further configured to take a final digital photograph and remove the average digital pixel brightness value of the trial digital photograph from digital pixel brightness values of the final digital photograph.

9. The digital camera of claim 6 further comprising dedicated hardware for constructing an exposure histogram, and wherein the computation of the average digital pixel brightness value of the trial photograph is facilitated by the use of an exposure histogram.

10. The digital camera of claim 6 wherein the interline transfer CCD electronic array light sensor further comprises a horizontal shift register, and wherein the vertical shift registers comprise at least two rows, and wherein charge contents of at least two rows of the vertical shift registers are shifted into the horizontal shift register between successive occasions when charge contents of the horizontal shift register are shifted out of the horizontal shift register.

11. A digital camera comprising:
a) means for detecting an effect of charge generated in the vertical shift register of an interline transfer CCD electronic array light sensor; and
b) means for removing the effect from a subsequent digital photograph.
